(19) United States
(12) Patent Application Publication
(10) Pub. No.: US 2009/0106732 A1
(43) Pub. Date: Apr. 23, 2009

(54) HIERARCHICAL DATA MODELS AND METHODS FOR NAVIGATING SAME

(76) Inventors: Daniel James Hanson, Edmonton (CA); Paul Allan Weatherbee, Edmonton (CA)

Correspondence Address: General Electric Company;GE Global Patent Operation, PO Box 861, 2 Corporate Drive, Suite 648, Shelton, CT, 06484, US

(21) Appl. No.: 11/874,969

(22) Filed: Oct. 19, 2007

(51) Int. Cl. G06F 9/44

(52) U.S. Cl. 717/104

(57) ABSTRACT

A method of programming a navigation system for a hierarchical data model includes coupling a processor in electronic data communication with an output device. The method also includes programming a hierarchical data model of a database within the processor. The hierarchical data model has a hierarchy representing a plurality of objects. At least one object of the plurality of objects has at least one attribute. The method further includes programming an entry point to at least a portion of the hierarchical data model within the processor. The entry point is programmed to generate an information list including each object of the plurality of objects having at least one common attribute. The information list is readable on the output device.

### BACKGROUND OF THE INVENTION

This invention relates generally to hierarchical data models and, more particularly, to large, hierarchical, distributed data models and methods for navigating same.

Generally, a hierarchical data model is a user-centric collection of objects defined by attributes. Such a data model is arranged in a hierarchy that has a relationship to associated data. Such hierarchies are typically configured to facilitate specific user roles and tasks that users may undertake. One such known hierarchy is programmed to represent equipment within an industrial facility such that maintenance personnel access only maintenance-related attributes of the equipment. Hierarchical data models are formed of at least one data tree, wherein such data trees are formed of a plurality of data branches. These data branches are arranged in a sequential pattern that substantially represents user priorities.

At least some known large, hierarchical, distributed data models are challenging to navigate. Data may be buried many levels deep in an obscure data branch. Also, some of the data may be dynamic by its nature due to, for example, periodic equipment replacements. Moreover, the data tree may contain data that is changeable by multiple users. Therefore, it may be difficult for any one user to maintain a knowledge of the data which is available to them. Moreover, at least some known methods of extracting data from databases are time-consuming and/or resource-consuming.

### BRIEF DESCRIPTION OF THE INVENTION

In one aspect, a method of programming a navigation system for a hierarchical data model is provided. The method includes coupling a processor in electronic data communication with an output device. The method also includes programming a hierarchical data model of a database within the processor. The hierarchical data model has a hierarchy representing a plurality of objects. Each object of the plurality of objects has at least one attribute. The method further includes programming an entry point to at least a portion of the hierarchical data model within the processor. The entry point is programmed to generate an information list including each object of the plurality of objects having at least one common attribute. The information list is readable on the output device.

In another aspect, a navigation system for a hierarchical data model is provided. The data model represents a plurality of objects. Each object of the plurality of objects has at least one attribute at least partially forming a hierarchy within the data model. The navigation system includes at least one entry point to at least a portion of the hierarchical data model. The entry point is programmed within at least one processor to generate an information list including each object of the plurality of objects having at least one common attribute. The information list is readable on at least one output device.

In a further aspect, a supervisory control and data acquisition (SCADA) system is provided. The SCADA system includes at least one processor and at least one output device coupled in electronic data communication with the at least one processor. The SCADA system also includes at least one hierarchical data model programmed within the at least one processor. The at least one hierarchical data model represents a plurality of objects. Each object of the plurality of objects has at least one attribute that at least partially forms a hierarchy within the at least one hierarchical data model. The SCADA system also includes a navigation system including at least one entry point to at least a portion of the at least one hierarchical data model. The at least one entry point is programmed within the processor to generate an information list including each object of the plurality of objects having at least one common attribute. The information list is readable on the at least one output device.

### BRIEF DESCRIPTION OF THE DRAWINGS

FIG. 1 is a schematic view of an exemplary supervisory control and data acquisition (SCADA) system;

FIG. 2 is a view of an exemplary user interface screen that may be used with the SCADA system shown in FIG. 1;

FIG. 3 is a view of an exemplary hierarchical tree that may be used with the SCADA system shown in FIG. 1;

FIG. 4 is a view of a portion of an entry point added to the hierarchical tree shown in FIG. 3; and

FIG. 5 is a view of an exemplary result of the entry point shown in FIG. 4.

### DETAILED DESCRIPTION OF THE INVENTION

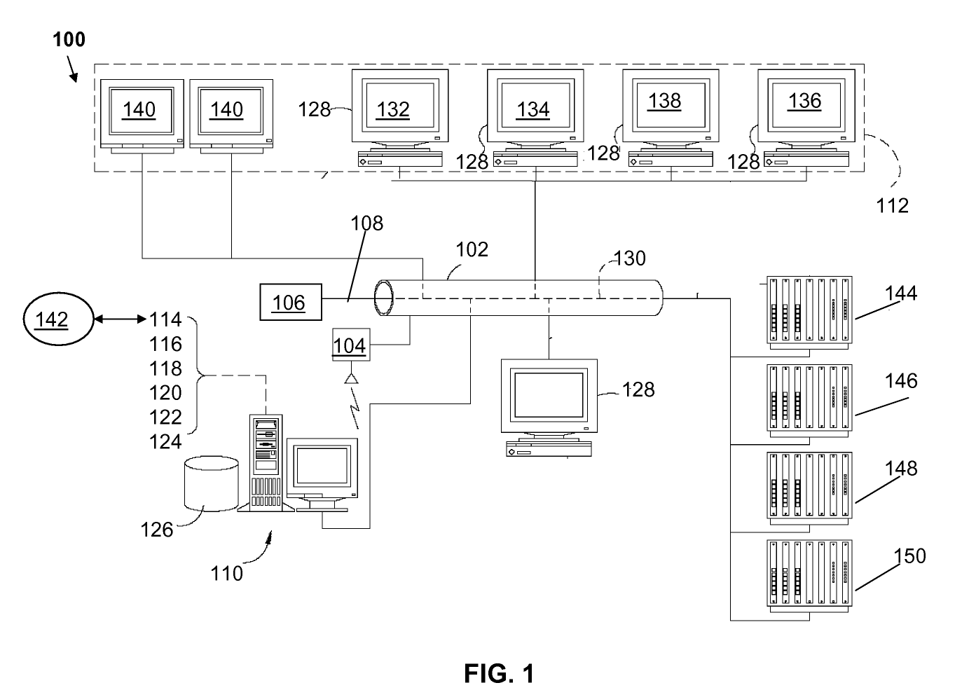

FIG. 1 is a schematic view of an exemplary supervisory control and data acquisition (SCADA) system 100. In the exemplary embodiment, system 100 is positioned within an industrial facility (not shown) that includes, but is not limited to, refineries, factories, assembly plants, power generation plants, and chemical plants. Alternatively, system 100 is positioned within commercial facilities, such as, but not limited to, hospitals, high-rise buildings, resorts, and amusement parks. Further, alternatively, system 100 is positioned in any facility. Also, in the exemplary embodiment, system 100 is a Proficy™ system that is commercially available from GE Fanuc Automation, Inc., Charlottesville, Va., United States of America. Alternatively, system 100 is any SCADA system, including, but not limited to, a distributed control system (DCS).

System 100 includes a network backbone 102. Network backbone 102 may be a hardwired data communication path fabricated from twisted pair cable, shielded coaxial cable or fiber optic cable, for example, or may be at least partially wireless. Any number of any equipment assemblies may be communicatively connected to network backbone 102. A first portion of the equipment assemblies may be hardwired to network backbone 102, and a second portion of the equipment assemblies may be wirelessly coupled to backbone 102 via a base station 104 that is communicatively coupled to system 100. Wireless base station 104 may be used to expand the effective communication range of system 100, such as with equipment or sensors located remotely from the industrial facility, but still interconnected to one or more systems similar to system 100 within the industrial facility.

System 100 may be configured to receive and display operational parameters associated with a plurality of equipment assemblies, and to generate automatic control signals and receive manual control inputs for controlling the operation of the equipment assemblies of the industrial facility. In the exemplary embodiment, system 100 includes sufficient software code and processing resources and is configured to control data processing and analysis activities associated with data received by system 100 that allows for on-line monitoring and diagnosis of the industrial plant equipment assemblies. Process parameter data may be collected from each equipment assembly, including, but not limited to, pumps and motors, associated process sensors, associated equipment controllers, as well as local environmental sensors, including for example, but not limited to, vibration, seismic, ambient temperature and ambient humidity sensors. The data may be pre-processed by a local diagnostic module or a remote input/output module (neither shown), or may transmitted to system 100 in raw form.

System 100 may operate independently to control the industrial facility, or may be communicatively coupled to one or more other control systems 106. Each system 106 may communicate with other systems 106 and system 100 through a network segment 108, or may communicate through any network topology, for example, but not being limited to, a star configuration (not shown).

In the exemplary embodiment, system 100 includes at least one server system 110 and a plurality of client systems 112 each coupled in electronic data communication with backbone 102. Server system 110 further includes a database server 114, an application server 116, a web server 118 a fax server 120, a directory server 122, and a mail server 124. In the exemplary embodiment, each server 114, 116, 118, 120, 122, and 124 is coupled in electronic data communication with server system 110. Alternatively, each server 114, 116, 118, 120, 122, and 124 is embodied in software executing on server system 110. Further, alternatively, any combinations of servers 114, 116, 118, 120, 122, and 124 may be embodied alone or in combination on separate server systems coupled in electronic data communication in a local area network (LAN), such as described herein. A disk storage unit 126 is coupled in electronic data communication with server system 110. In addition, a plurality of workstations 128 that includes, but is not limited to, a system administrator workstation, a user workstation, and/or a supervisor workstation is coupled in electronic data communication with a LAN 130. Alternatively, workstations 128 are coupled to LAN 130 using an Internet link or are connected through an Intranet (neither shown).

Each workstation 128 may be a personal computer having a web browser. Although the functions performed at the workstations typically are illustrated as being performed at respective workstations 128, such functions can be performed at one of many personal computers coupled to LAN 130. Workstations 128 are described as being associated with separate exemplary functions only to facilitate an understanding of the different types of functions that can be performed by individuals having access to LAN 130.

Server system 110 is configured to be communicatively coupled to various individuals, including employees 132 and third parties, for example, but not limited to, service providers 134. The communication in the exemplary embodiment is illustrated as being performed using the Internet. However, any other wide area network (WAN) type communication can be utilized in alternative embodiments, that is, the systems and processes are not limited to being practiced using the Internet.

In the exemplary embodiment, any authorized individual having a workstation 128 can access system 100. At least one of the client systems may include a manager workstation 136 located at a remote location. Also, workstations 128 are configured to communicate with server system 110. Furthermore, fax server 120 communicates with remotely located client systems, including a client system 138 using a telephone link (not shown). Fax server 120 is configured to communicate with other client systems 132, 134, and 136 as well.

Computerized modeling and analysis tools associated with system 100 are stored in server system 110 and can be accessed by a requester at any one of client systems 112. In the exemplary embodiment, client systems 112 are computers including a web browser, such that server system 110 is accessible to client systems 112 that are interconnected to the Internet through interfaces including a network, such as LAN 130. Alternatively, such Internet connectivity is facilitated by a wide area network (WAN), dial-in-connections, cable modems and special high-speed ISDN lines (none shown). Also, alternatively, client systems 112 are any device capable of interconnecting to the Internet including, but not limited to, a web-based phone, personal digital assistant (PDA), or other web-based connectable equipment. System 100 also includes a plurality of remote monitoring stations 140 coupled in electronic data communication with LAN 130. Such stations 140 facilitate remote monitoring of any processes associated with system 100.

In the exemplary embodiment, database server 114 is connected to a database 142 that is embodied within server 114. Database 142 contains information about the industrial facility, as described below in greater detail. Database 142 is structured with a hierarchical database model (not shown in FIG. 1). Alternatively, database 142 has any structure that facilitates operation of system 100 as described herein. In an alternative embodiment, centralized database 142 is stored on server system 110 and can be accessed by potential users at one of client systems 112 by logging onto server system 110 through one of client systems 112. In a further alternative embodiment, database 142 is stored remotely from server system 110 and server 114 and may be non-centralized. Further, alternatively, other industrial facility systems may provide data that is accessible to server system 110 and/or client systems 112 through independent connections to LAN 130.

In the exemplary embodiment, system 100 includes a plurality of processors (not shown) that are embedded within server system 110, servers 114, 116, 118, 120, 122, and 124, and on work stations 128. System 100 also includes a plurality of output devices that include server system 110, servers 114, 116, 118, 120, 122, and 124, work stations 128, and on monitors 140. The output devices may also includes printers and any other device that may be coupled in electronic data communication with system 100 as described above.

Also, in the exemplary embodiment, system 100 includes a plurality of controllers. Specifically, system 100 includes a Line 1 Assembly Controller 144, a Line 1 Mixer Controller 146, a Line 2 Assembly Controller 148, and a Submixer Controller 150. Each controller 144, 146, 148 and 150 is coupled in electronic data communication with system 100 via methods as discussed above.

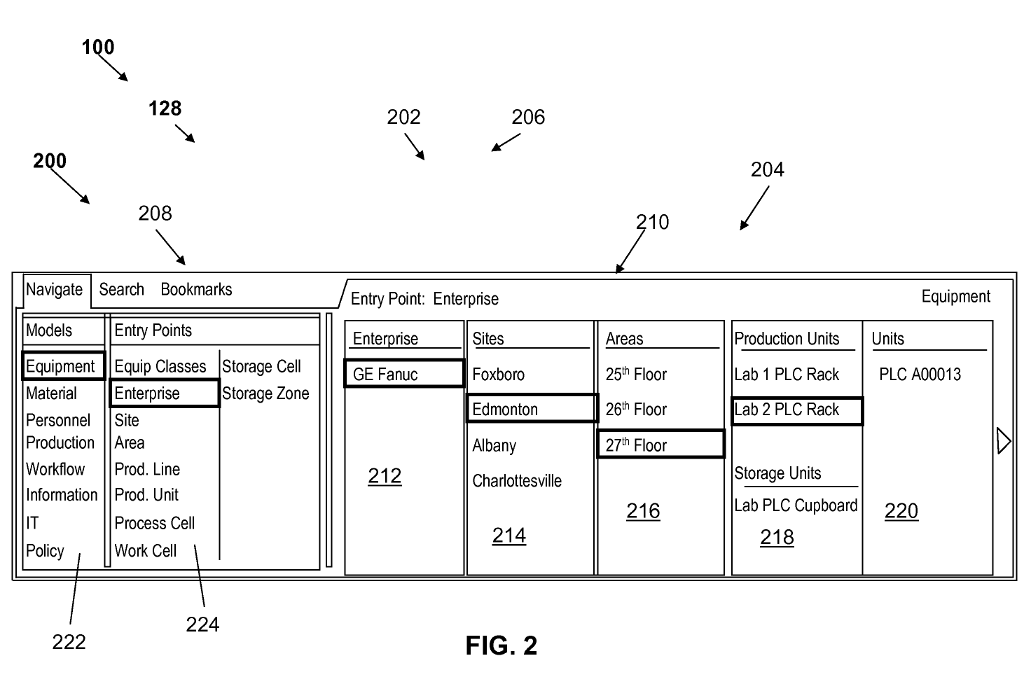

FIG. 2 is a view of an exemplary user interface screen 200 that may be used with SCADA system 100. System 100 includes human-machine interface (HMI) features that include screen 200. Database 142 includes a hierarchical data model 202 that is at least partially illustrated on screen 200, wherein screen 200 includes a traditional hierarchical navigator 204. Navigator 204 represents a first portion of a navigation system 206 for hierarchical data model 202 that is embedded within and integrated with system 100. In the exemplary embodiment, navigation system 206 is integrated with the processors and output devices described above. A second portion of navigation system 206 is also illustrated on screen 200 as an entry point navigator 208.

In the exemplary embodiment, hierarchical data model 202 is a large, hierarchical, distributed data model with at least one data tree (not shown), wherein each data tree has a plurality of data branches (not shown). The data tree and the data branches are formed of defined attributes of objects. Specifically, hierarchical data model 202 is a user-centric collection of objects, arranged in a hierarchy, which are organized to facilitate specific roles and/or tasks that users may undertake. Separating data into models, hierarchy navigation by people who are responsible for maintenance of equipment is facilitated. Specifically, navigation through the hierarchy without being exposed to objects of which they have no interest is facilitated. Such hierarchy navigation is typically accomplished by multiple drilling activities through a plurality of user-selected menus.

Hierarchical navigator 204 illustrates at least a portion of hierarchical data model 202. Typically, the industrial facility includes a plurality of equipment assemblies. Each assembly has a number of attributes, such assemblies and attributes forming the data trees and data branches discussed above. For example, the equipment assemblies in the industrial facility are organized into an equipment model 210. In the embodiment shown, equipment model 210 includes five panels. Specifically, equipment model 210 includes a first panel 212 that illustrates a list of items or attributes associated with the equipment assemblies within the industrial facility at the “Enterprise” level within the data tree. In the exemplary embodiment, “GE Fanuc” is the sole attribute at such a relatively high level within the hierarchy. “GE Fanuc” is selected (as illustrated by a bolded outline) either by default or through user action.

Selection of an attribute in panel 212 populates a second panel 214. In the exemplary embodiment, panel 214 is populated with four “Sites” attributes including “Foxboro”, “Edmonton”, “Albany”, and “Charlottesville”. Also, in the exemplary embodiment, panels 212 and 214 have a “parent” and “children” relationship, respectively. Further drilling-down activities by the user include selection of the “Edmonton” attribute (as illustrated by a bolded outline) such that a third panel 216 is populated with “Areas” attributes that include the attributes of “25th floor”, “26th floor”, and “27th floor”. Panels 214 and 216 have a “parent” and “children” relationship, respectively. Additional drilling-down activities by the user include selection of the “27th floor” attribute (as illustrated by a bolded outline) such that a fourth panel 218 is populated with “Production Units” and “Storage Units” attributes. Panels 216 and 218 have a “parent” and “children” relationship, respectively. The attribute “Production Units” includes a plurality of attributes that include “Lab 1 PLC Rack” and “Lab 2 PLC Rack”. The attribute “Storage Units” includes a single attribute “Lab 1 PLC Cupboard”. Subsequent drilling-down activities by the user include selection of the “Lab 2 PLC Rack” attribute (as illustrated by a bolded outline) such that a fifth panel 220 is populated with “Units” attributes that include a “PLC A00013” attribute. Panels 218 and 220 have a “parent” and “children” relationship, respectively.

Previous SCADA systems that did not include navigation system 206 required drilling through a plurality of individual screens that were similar to each of panels 212 through 220. Specifically, previously, generating a list of all of the PLCs within the Edmonton site would require operator selection and drilling through individual screens similar to each of panels 216 through 220 for each of the “Production Units” and “Storage Units” attributes shown in panel 218 for the three “Areas” attributes in panel 216. Such drilling is time-consuming.

Navigation system 206 also includes an entry point navigator 208 that cooperates with hierarchical navigator 204. Hierarchical navigator 204 is a horizontally-based navigator for traversing a list of objects and attributes that result from operation of entry point navigator 208. Entry point navigator 208 includes a first panel 222 that includes a plurality of “Models” and a second panel 224 that includes a plurality of “Entry Points” wherein each “Model” includes at least one corresponding “Entry Point”. In the exemplary embodiment, the “Equipment” model as selected in panel 222 (as illustrated by a bolded outline) includes ten “Entry Points” wherein a selected entry point in panel 224 is “Enterprise” (as illustrated by a bolded outline). Such selection populates panel 212 and user selection within panel 212 facilitates user selections in panels 214 through 220 as described above.

In the exemplary embodiment, a layer of markup language is used to program a virtual layer (not shown) that is formed over the existing hierarchy. Any suitable markup programming language is used that facilitates operation of navigation system 206. The aforementioned data is organized into models as illustrated within panel 222. Such models are logical groupings of data associated with objects and the associated attributes, wherein such groupings are at least partially dependent on user requirements. Further categorization of the objects and their attributes facilitate at least some apparent data tree and data branch reorganization based on defined entry points into the data model. Defining the entry points is discussed further below.

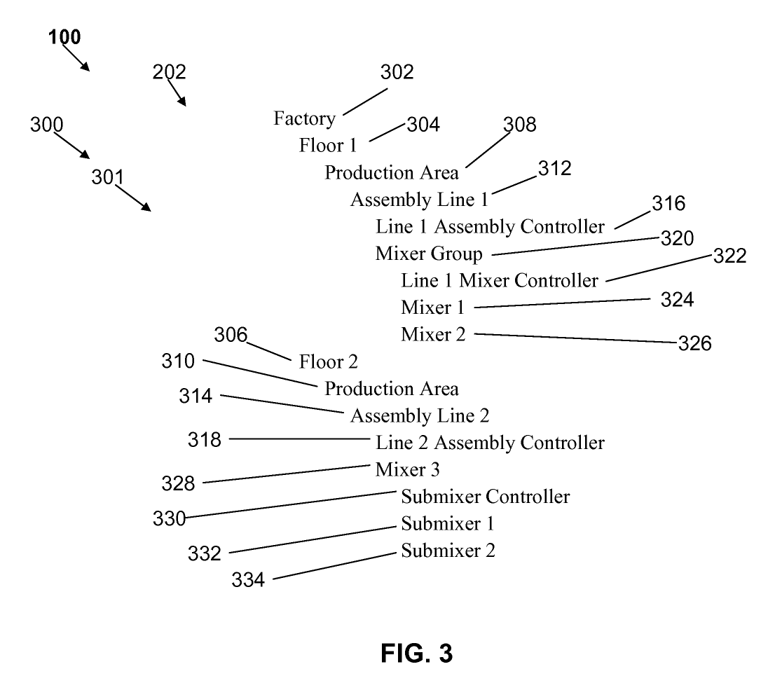

FIG. 3 is a view of an exemplary hierarchical tree 300 that may be used with SCADA system 100. Tree 300 is a portion of hierarchical data model 202 having a discernable hierarchy 301. Tree 300 includes a first branch 302 titled “Factory”. Branch 302 includes two subordinate branches 304 and 306 titled “Floor 1” and “Floor 2”, respectively. Branch 304 includes a “Production Area” branch 308 and branch 306 includes a “Production Area” branch 310. Branch 308 includes a “Assembly Line 1” branch 312 and branch 310 includes a “Assembly Line 2” branch 314.

Moreover, branch 312 includes a “Line 1 Assembly Controller” branch 316 and branch 314 includes a “Line 2 Assembly Controller” branch 318. Also, branch 312 includes a “Mixer Group” branch 320 that subsequently includes a “Line 1 Mixer Controller” branch 322, a “Mixer 1” branch 324 and a “Mixer 2” branch 326. Furthermore, branch 314 includes a “Mixer 3” branch 328 that subsequently includes a “Submixer Controller” branch 330, a “Submixer 1” branch 332 and a “Submixer 2” branch 334.

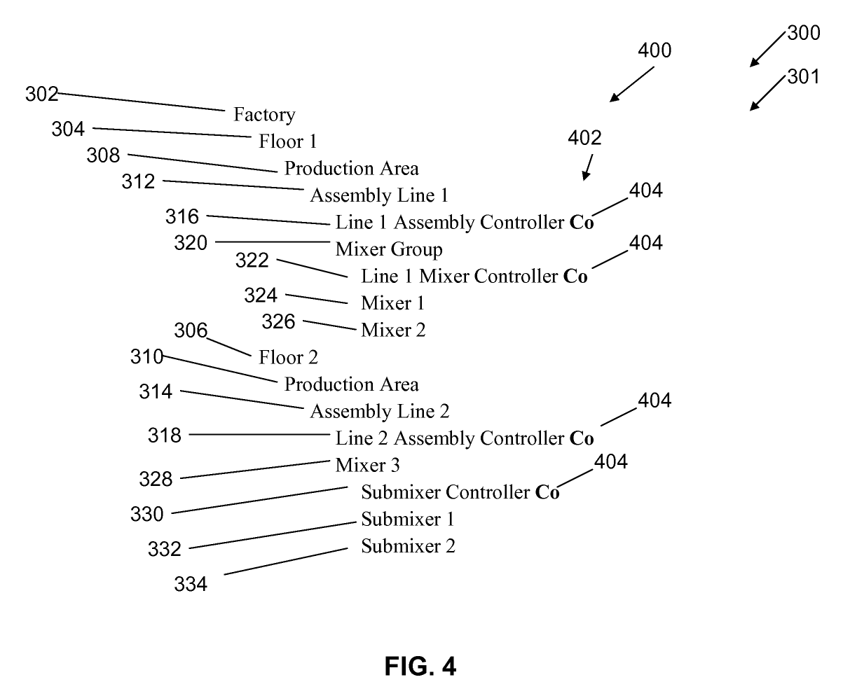

FIG. 4 is a view of a portion of an entry point 400 added to hierarchical tree 300. Entry point 400 is programmed in a layer of markup language to flatten hierarchy 301 of objects based on defined attributes without using sequential query logic (SQL) queries or manipulating table schemas. Programming entry point 400, as contrasted to programming SQL queries, facilitates more efficient and cost effective query programming, accelerated performance, and more efficient use of information technology resources. In the exemplary embodiment, entry point 400 is a configurable “view” into the hierarchy of data model 202 that leverages bitmap/radix implementation to “pull” objects out of hierarchy 301 and display them in a list, as discussed further below. In the exemplary embodiment, any number of entry points for any number of objects for any number of views are programmed to facilitate operation of system 100 as described within.

Entry point 400 includes a plurality of bitfields 402 that are attached to every object in hierarchy 301. In general, individual bits (not shown) of each bitfield may be programmed to represent any definable attribute or characteristic of an object, and an entry point is defined by programming an equivalent bitmask (not shown).

An illustrative example assumes that all objects defined in system 100 are represented by four bits, each bit representing one attribute. Specifically, Bit 0 represents an object that is a mixer, Bit 1 represents an object that is currently in certification, Bit 2 represents an object that is located in Edmonton, and Bit 3 represents an object that is located in Foxboro. This example is scalable to the extent that thousands of bits representing numerous attributes are feasible. Bits 0 through 3 are represented in the order of Bit 3-Bit 2-Bit 1-Bit 0.

A first example of a bitfield defines a Mixer 1 that is an Edmonton mixer in certification with a bitfield of 0111. Also, a second example of a bitfield defines a Mixer 2 that is an Edmonton mixer not certified with a bitfield of 0101. Further, a third example of a bitfield defines a Mixer 3 that is a certified Foxboro mixer with a bitfield of 1011. Moreover, a fourth example of a bitfield defines a Mixer 4 that is an uncertified Foxboro mixer with a bitfield of 1001.

Moreover, for example, an entry point titled “All Edmonton Mixers” is programmed by generating a bitmask “0101” that is applied to all objects in the associated hierarchy using a logical “AND” operation. Subsequently, all objects that are not at least partially defined with the appropriate attributes are filtered out. Such an operation is executed in the memory portion of a processing device without having to query a database, thereby generating substantially instantaneous results. Subsequently all objects that have both attributes of being located in Edmonton and being a mixer are retrieved, and a brevity of time associated with the operation is substantially similar to a temporal performance with a single attribute being filtered. Generally, any result from the logical expression “IF (object bitfield) AND (entry point bitmask)” that yields a result that is identical to the bitmask expression is a “hit”. Specifically, in this example, since Mixer 1 has a bitfield of “0111”, that corresponds to a mixer in Edmonton in certification, that is logically associated with an “AND” operation with the “Edmonton Mixers” entry point bitmask “0101”, a result of “0101” is generated. Further, specifically, using bitmask “0101” in a logical “AND” association with Mixer 2 having a bitfield of “0101”, generates a result of “0101” and, therefore, a “hit” on Mixer 2. Mixers 3 and 4, with bitfields of “1011” and “1001”, respectively, generate results of “0001” for both, and since “0001” does not match “0101”, Mixers 3 and 4 are filtered out. In summary, using a bitmask of “0101” that corresponds to “All Edmonton Mixers” generates a result of Mixer 1 and Mixer 2.

Furthermore, entry point attributes may be combined in more complex ways. Using an “OR” operation may generate a non-zero result, which in this case, corresponds to a “hit”. For example, a command, or query, of “any equipment in Edmonton, OR any mixer” will require a bitmask of “0101” and a bitmask of “0001”. Using Boolean logic to combine these to a resultant bitmask of “0001” (that is, “0111” OR “1001”), and using that resultant bitmask to filter all objects in the hierarchy, then all objects that generate a non-zero result will generate a “hit”. In this example, Mixers 1, 2, 3, and 4 each generate a “hit”.

As a further example, entry point attributes may be combined in more complex ways using an “AND” operation in conjunction with an “OR” operation. Specifically, using the same four mixers and the four bitfields described above, a query can be generated for “a mixer that is certified in Edmonton, OR any mixer that is in Foxboro and uncertified”. In using a multi-pass approach, the previously discussed use of a “bitmask” of “0101” that corresponds to “All Edmonton Mixers” generates a result of Mixer 1 and Mixer 2. Secondly, a bitmask of “1001” for uncertified Foxboro mixers is used with all four mixers that results in a “hit” for Mixer 4, while Mixers 1, 2, and 3 are filtered out. Therefore, in summary, this method generates a result of Mixer 1, Mixer 2, and Mixer 4.

Either an “OR” or “AND” operation, each by itself, can be performed with one query, no matter how many attributes are tested for. As discussed above, in the “OR” case, a “hit” is any object that returns a non-zero result. In the “AND” case, the resultant bitfield must exactly match the original mask. Often, using Boolean algebra, queries that contain both “OR” and “AND” operators can be reduced to a single “OR” or “AND”, so that one pass through the object list is sufficient to generate the desired results. Therefore, no matter how complex the query is, the system performance is substantially similar because any complex set of Boolean bitmasks can be reduced to a single mask using Boolean algebra, and that resultant set is the only mask that needs to be applied to the object set.

Prior to embedding navigation system 206 within system 100, if a user was tasked to maintain software on the various controllers in the industrial facility, the user would have to drill through multiple assembly lines and down through arbitrary levels to find all the controllers. In the exemplary embodiment, using entry points and categorization, all controllers are “marked up” with a categorization that is equivalent to an entry point for “controllers”. Specifically, referring to FIG. 4, a tag 404 is programmed in a markup language that at least partially forms entry point 400, titled “Controllers”. More specifically, in the exemplary embodiment, a portion (in this case a single bit) of a large category bitfield (not shown) with a plurality of bits, is programmed to be substantially equivalent to an entry of “Co”. Such equivalent bit programming of “Co” represents the tag associated with each object, would not be visible to the user, and is configured to denote any associated object with the associated attribute of “controller” as a controller to the user.

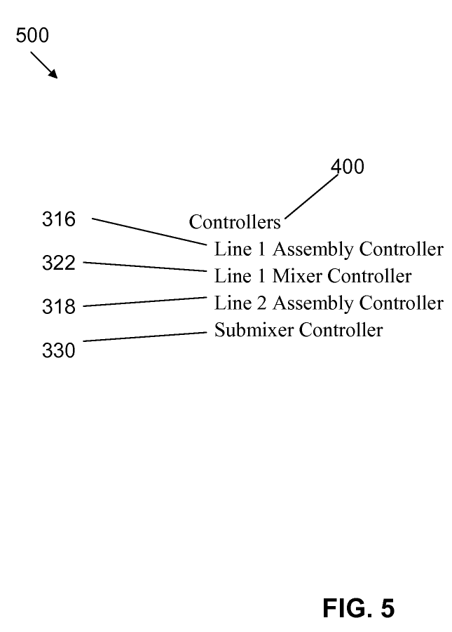

FIG. 5 is a view of an exemplary result 500 of entry point 400 shown in FIG. 4. An exemplary method of programming navigation system 206 for hierarchical data model 202 includes coupling a processor (for example, server system 110 shown in FIG. 1) in electronic data communication with an output device (for example, work stations 128 shown in FIG. 1). The method also includes programming hierarchical data model 202 of database 142 (shown in FIG. 1) within the processor. Hierarchical data model 202 includes hierarchy 301 representing a plurality of objects. At least one object of the plurality of objects has at least one attribute. The method further includes programming an entry point 400 to at least a portion of hierarchical data model 202 within the processor. The technical effect is to program at least one entry point 400 to generate an information list, that is result 500, including each object of the plurality of objects having at least one common attribute. The information list is readable on the output device.

In the exemplary embodiment, entry point 400 is titled “Controllers”. Applying entry point 400 with the appropriate bitmask (not shown) that includes sufficient programming to identify all of the objects having an associated bitfield that includes a bit representative of the tag “Co” returns the resultant list illustrated in FIG. 5. Specifically, objects 316, 322, 318, and 330 are identified by selection of entry point 400.

Furthermore, since categories are represented by bitfields, Boolean logic can be applied to create arbitrary groupings of objects. For example, if all objects on Assembly Line 1 are categorized with a “Line 1” bit, and all controllers have a “Controller” bit, then an entry point called “Line 1 Controllers” may be programmed to retrieve all the objects that have both bits set. Alternatively, a category titled “Line 1-Except Controllers” may be programmed by implementing a logical “Line 1 AND NOT Controllers” operation via the object bitfields.

Navigation system 206, in the exemplary embodiment, provides for a number of advantages over other methods of database data searches that include, but are not limited to, full-text searches, hyperlinks, and traditional collapsible-tree navigators. Specifically, the combination of data models, entry points, and categorization based on bitfields facilitates presenting a complex hierarchy of data in optimal ways to meet the needs of specific users. More specifically, the complex hierarchy is selectively flattened by configuring defined entry points using characteristics that are useful to the user. Therefore, each user may create categorizations for displaying his or her unique data queries, thereby facilitating organizational flexibility for the users while maintaining a fixed hierarchy. Moreover, user-defined queries and filtering are executed using a front end with intuitive graphical navigation having readily available navigation features that are user-unique and configurable, which distinguish navigation system 206 visually and conceptually from traditional tree-style navigators. Navigation system 206 subsequently facilitates a reduction of the time and computing resources needed for drilling down into the hierarchy, facilitates easier navigation down the branches of data, and facilitates a reduction of scrolling and/or clicking to find their data.

Moreover, in the exemplary embodiment, some of the limitations of relational databases are avoided. For example, in a relational database, if the tables are not initially set up with the proper keys and indexes on the appropriate columns, performance suffers. Specifically, over time as the need for searching for data changes, either the database itself has to be modified with new columns and indexes added (referred to as reindexing) or performance will likely suffer. Therefore, navigation system 206 is substantially extensible in the sense that new attributes for queries can be added at any time, and entry points to leverage the queries with those attributes may also be added without negatively impacting performance.

Furthermore, one feature of most databases is that multiple users have access to change and add data. Moreover, many users may have difficulty forming a “mental picture” of the portion of the hierarchy that is of interest to them. Therefore, better visibility into user-specific data using categorizations to prioritize and organize critical objects, updated with the most recent data, regardless of the source of data entry, facilitates more efficient performance of user tasks that rely upon the data.

The method for programming a navigation system for a hierarchical data model as described herein facilitates assembly of a supervisory control and data acquisition (SCADA) system. More specifically, the method of navigating the hierarchical data model as described above facilitates decreasing time and labor associated with maintenance and operational activities for complex industrial facilities with dynamic material configurations.

Exemplary embodiments of navigation systems as associated with hierarchical data models and SCADA systems are described above in detail. The methods, apparatus and systems are not limited to the specific embodiments described herein or to the specific illustrated hierarchical data models and SCADA systems.

While the invention has been described in terms of various specific embodiments, those skilled in the art will recognize that the invention can be practiced with modification within the spirit and scope of the claims.

What is claimed is:

1. A method of programming a navigation system for a hierarchical data model, said method comprising:
coupling a processor in electronic data communication with an output device;
programming a hierarchical data model of a database within the processor, the hierarchical data model having a hierarchy representing a plurality of objects, at least one object of the plurality of objects having at least one attribute; and
programming an entry point to at least a portion of the hierarchical data model within the processor, the entry point programmed to generate an information list including each object of the plurality of objects having at least one common attribute, the information list being readable on the output device.

2. A method in accordance with claim 1 further comprising programming at least one virtual layer over the hierarchy wherein the entry point is resident within the at least one virtual layer.

3. A method in accordance with claim 2 wherein programming at least one virtual layer over the hierarchy comprises programming the at least one virtual layer using at least one markup language.

4. A method in accordance with claim 2 wherein programming an entry point comprises programming at least one bitmask within the at least one virtual layer.

5. A method in accordance with claim 1 wherein programming a hierarchical data model comprises programming at least one categorizing bitfield within the hierarchy, wherein the at least one categorizing bitfield is programmed to at least partially define the at least one common attribute.

6. A method in accordance with claim 1 wherein programming an entry point to at least a portion of the hierarchical data model to generate an information list having each object of the plurality of objects having at least one common attribute comprises flattening at least a portion of the hierarchy to generate the information list.

7. A method in accordance with claim 1 wherein programming a hierarchical data model of a database comprises programming at least one data tree including a plurality of data branches, each data branch of the plurality of data branches includes at least one object of the plurality of objects at least partially defined therein by the at least one attribute, wherein the entry point is programmed to populate the information list with at least one object defined within the hierarchical data model having the at least one common attribute.

8. A method in accordance with claim 1 wherein programming a hierarchical data model of a database comprises programming the hierarchical data model to be substantially representative of the database including the at least one attribute of each at least one object of the plurality of objects.

9. A navigation system for a hierarchical data model, the data model representing a plurality of objects, each object of the plurality of objects having at least one attribute at least partially forming a hierarchy within the data model, said navigation system comprising at least one entry point to at least a portion of the hierarchical data model, said at least one entry point programmed within at least one processor to generate an information list comprising each object having at least one common attribute, said information list being readable on at least one output device.

10. A navigation system for a hierarchical data model in accordance with claim 9 further comprising at least one virtual layer programmed over the hierarchy wherein said at least one entry point is resident within said at least one virtual layer.

11. A navigation system for a hierarchical data model in accordance with claim 10 wherein said at least one virtual layer is programmed with at least one markup language, said at least one virtual layer further programmed to facilitate flattening at least a portion of the hierarchy to form said information list.

12. A navigation system for a hierarchical data model in accordance with claim 9 wherein said at least one entry point comprises at least one bitmask that is programmed to filter at least one categorizing bitfield that at least partially defines the at least one common attribute.

13. A navigation system for a hierarchical data model in accordance with claim 9 wherein the hierarchical data model includes at least one data tree including a plurality of data branches, wherein each data branch of the plurality of data branches includes at least one object of the plurality of objects at least partially defined therein by the at least one attribute, said at least one entry point is programmed to populate said information list with each object of the plurality of objects defined within the hierarchical data model having the at least one common attribute.

14. A navigation system for a hierarchical data model in accordance with claim 13 wherein the hierarchical data model is substantially representative of a database including the at least one attribute of each object.

15. A supervisory control and data acquisition (SCADA) system comprising:
at least one processor;
at least one output device coupled in electronic data communication with said at least one processor;
at least one hierarchical data model programmed within said at least one processor, said at least one hierarchical data model representing a plurality of objects, each object of the plurality of objects having at least one attribute least partially forming a hierarchy within said at least one hierarchical data model; and
a navigation system comprising at least one entry point to at least a portion of said at least one hierarchical data model, said at least one entry point programmed within said at least one processor to generate an information list comprising each object of the plurality of objects having at least one common attribute, said information list being readable on said at least one output device.

16. A SCADA system in accordance with claim 15 further comprising at least one virtual layer programmed over said hierarchy wherein said at least one entry point is resident within said at least one virtual layer.

17. A SCADA system in accordance with claim 16 wherein said at least one virtual layer is programmed with at least one markup language, said at least one virtual layer further programmed to facilitate flattening at least a portion of said hierarchy to form said information list.

18. A SCADA system in accordance with claim 15 wherein said at least one entry point comprises at least one bitmask that is programmed to filter at least one categorizing bitfield that at least partially defines the at least one common attribute.

19. A SCADA system in accordance with claim 15 wherein said at least one hierarchical data model comprises at least one data tree including a plurality of data branches, wherein each said data branch of the plurality of data branches includes at least one object of the plurality of objects at least partially defined therein by the at least one attribute, said at least one entry point is programmed to populate said information list with each object of the plurality of objects defined within said at least one hierarchical data model having the at least one common attribute.

20. A SCADA system in accordance with claim 19 wherein said at least one hierarchical data model is substantially representative of a database including the at least one attribute of each object.
